(19) United States
(12) Patent Application Publication
(10) Pub. No.: US 2024/0078449 A1
(43) Pub. Date: Mar. 7, 2024

(54) LOGICAL EXPRESSION PROCESSING DEVICE, LOGICAL EXPRESSION PROCESSING METHOD, AND LOGICAL EXPRESSION PROCESSING PROGRAM

(71) Applicant: NEC Corporation, Minato-ku, Tokyo (JP)

(72) Inventor: Kazeto Yamamoto, Tokyo (JP)

(73) Assignee: NEC Corporation, Minato-ku, Tokyo (JP)

(21) Appl. No.: 18/280,385

(22) PCT Filed: Mar. 10, 2021
(86) PCT No.: PCT/JP2021/009436

§ 371 Date: Sep. 5, 2023

(51) Int. Cl. G06N 5/04; G06N 5/02

(52) U.S. Cl. CPC G06N 5/04; G06N 5/02

(57) ABSTRACT

A logical expression processing apparatus includes at least one processor, the at least one processor carrying out: an acquisition process of acquiring background knowledge information and query information; a processing execution process of processing the logical formulas of at least one of the background knowledge information and the query information that have been acquired in the acquisition process, and acquiring processed background knowledge information and processed query information; an inference execution process of executing logical inference using, as inputs, the processed background knowledge information and the processed query information; and an evaluation process of outputting at least one of the processed background knowledge information and the processed query information, depending on whether or not an execution result of the logical inference satisfies a predetermined requirement.

### TECHNICAL FIELD

The present invention relates to a logical expression processing apparatus, a logical expression processing method, and a logical expression processing program, and in particular, to a logical expression processing apparatus, a logical expression processing method, and a logical expression processing program each of which is for processing input information in logical inference.

### BACKGROUND ART

A logical inference model is generally a model to which a query logical formula (query) and background knowledge that are expressed in a logical formula(s) are inputted and from which an inference result is outputted. Rough classifications of the logical inference model include a deductive reasoning model and an abductive reasoning model. Typical examples of the deductive reasoning model include Markov logic networks and answer set programming. Typical examples of the abductive reasoning model include weighted abduction and etcetera abduction.

Non-Patent Literature 1 discloses a method for implementing weighted abduction, which is one of abductive reasoning models, on a computer. Patent Literature 2 discloses a formal definition of Markov logic networks which serve as one type of deductive reasoning models.

Numerous attempts have been made to construct an artificial intelligence system in which a logical inference model is applied to a real problem. For example, Patent Literature 1 discloses a method in which an abductive reasoning model is applied to a support for driving an automobile.

### CITATION LIST

### Patent Literature

### Patent Literature 1

Japanese Patent Application Publication Tokukai No.

2017-187848

### Non-Patent Literature

### Non-patent Literature 1

Naoya Inoue and Kentaro Inui, ILP-based Reasoning for Weighted Abduction, In Proceedings of AAAI Workshop on Plan, Activity and Intent Recognition, pp. 25-32, August 2011.

### Non-patent Literature 2

Matthew Richardson and Pedro Domingos, Markov Logic Networks, Machine Learning, 62, 2006.

### SUMMARY OF INVENTION

### Technical Problem

In an attempt to construct an artificial intelligence system in which a logical inference model is applied to a real problem, a major problem exists in a step of adjusting a logical expression format of input information, such as query logical formulas and background knowledge, so that the logical inference model will behave as expected. Conventionally, in order to carry out this step, it has been necessary to carry out a detailed examination by a human resource familiar with both of a technical domain to which the logical inference model is applied and a logical inference model which is to be used. Accordingly, this step has been a serious bottleneck in both time and cost. Although this problem always occurs in a case where a logical inference model is applied to a real problem, there has been no known approach to this problem.

An example aspect of the invention is attained in view of the above problem. An example object of the invention is to provide a technique for efficiently adjusting a logical expression format of input information in logical inference.

### Solution to Problem

A logical expression processing apparatus in accordance with an example aspect of the invention includes: an acquisition unit that acquires background knowledge information and query information, the background knowledge information expressing, in one or more logical formulas, a set of rules according to each of which if an antecedent is true, a consequent is true, the query information expressing one or more observed facts in one or more logical formulas; a processing execution unit that processes the logical formulas of at least one of the background knowledge information and the query information that have been acquired by the acquisition unit, and acquires processed background knowledge information and processed query information; an inference execution unit that executes logical inference using, as inputs, the processed background knowledge information and the processed query information; and an evaluation unit that outputs at least one of the processed background knowledge information and the processed query information, depending on whether or not an execution result of the logical inference satisfies a predetermined requirement.

In a logical expression processing method in accordance with an example aspect of the invention, one or more computers are caused to: acquire background knowledge information and query information, the background knowledge information expressing, in one or more logical formulas, a set of rules according to each of which if an antecedent is true, a consequent is true, the query information expressing one or more observed facts in one or more logical formulas; process the logical formulas of at least one of the background knowledge information and the query information that have been acquired, and acquire processed background knowledge information and processed query information; execute logical inference using, as inputs, the processed background knowledge information and the processed query information; and output at least one of the processed background knowledge information and the processed query information, depending on whether or not an execution result of the logical inference satisfies a predetermined requirement.

A logical expression processing program in accordance with an example aspect of the invention causes a computer to function as a logical expression processing apparatus, the logical expression processing program causing the computer to function as: an acquisition unit that acquires background knowledge information and query information, the background knowledge information expressing, in one or more logical formulas, a set of rules according to each of which if an antecedent is true, a consequent is true, the query information expressing one or more observed facts in one or more logical formulas; a processing execution unit that processes the logical formulas of at least one of the background knowledge information and the query information that have been acquired by the acquisition unit, and acquires processed background knowledge information and processed query information; an inference execution unit that executes logical inference using, as inputs, the processed background knowledge information and the processed query information; and an evaluation unit that outputs at least one of the processed background knowledge information and the processed query information, depending on whether or not an execution result of the logical inference satisfies a predetermined requirement.

### Advantageous Effects of Invention

An example aspect of the invention makes it possible efficiently adjust a logical expression format of input information in logical inference.

### BRIEF DESCRIPTION OF DRAWINGS

FIG. 1 is a block diagram illustrating an example of a configuration of a logical expression processing apparatus according to a first example embodiment of the invention.

FIG. 2 is a flowchart showing an example of a flow of a logical expression processing method according to the first example embodiment of the invention.

FIG. 3 is a block diagram illustrating an example of a configuration of a logical expression processing apparatus according to a second example embodiment of the invention.

FIG. 4 is a flowchart showing an example of a flow of a logical expression processing method according to the second example embodiment of the invention.

FIG. 5 is a diagram illustrating an example of a data structure of background knowledge information according to the second example embodiment of the invention.

FIG. 6 is a diagram illustrating an example of unprocessed background knowledge information according to the second example embodiment of the invention.

FIG. 7 is a diagram illustrating an example of processed background knowledge information according to the second example embodiment of the invention.

FIG. 8 is a diagram illustrating an example of a data structure of query information according to the second example embodiment of the invention.

FIG. 9 is a diagram illustrating an example of the query information according to the second example embodiment of the invention.

FIG. 10 is a diagram illustrating an example of a data structure of correct answer information according to the second example embodiment of the invention.

FIG. 11 is a diagram illustrating an example of a correct answer inference result according to the second example embodiment of the invention.

FIG. 12 is a diagram illustrating an example of processing of the background knowledge information and the query information according to the second example embodiment of the invention.

FIG. 13 is a diagram illustrating an example of a data structure of execution result information according to the second example embodiment of the invention.

FIG. 14 is a block diagram illustrating an example of a configuration of a logical expression processing apparatus according to a third example embodiment of the invention.

FIG. 15 is a flowchart showing an example of a flow of a logical expression processing method according to the third example embodiment of the invention.

FIG. 16 is a block diagram illustrating an example of a hardware configuration of a logical expression processing apparatus according to each example embodiment of the invention.

### DESCRIPTION OF EMBODIMENTS

### First Example Embodiment

The following description will discuss in detail a first example embodiment of the invention, with reference to drawings. The present example embodiment is an embodiment that serves as a base for example embodiments which will be described later.

<Configuration of Apparatus>

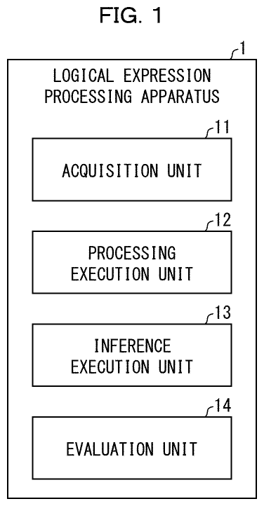

The following will discuss a configuration of a logical expression processing apparatus 1 according to the present example embodiment, with reference to FIG. 1. FIG. 1 is a block diagram illustrating an example of the configuration of the logical expression processing apparatus 1.

As illustrated in FIG. 1, the logical expression processing apparatus 1 includes an acquisition unit 11, a processing execution unit 12, an inference execution unit 13 and an evaluation unit 14.

The acquisition unit 11 acquires background knowledge information and query information. The background knowledge information expresses, in one or more logical formulas, a set of rules according to each of which if an antecedent is true, a consequent is true. The query information expresses an observed fact in one or more logical formulas.

The processing execution unit 12 processes the logical formula(s) of the background knowledge information and/or the query information that have been acquired by the acquisition unit 11, and acquires processed background knowledge information and processed query information.

The inference execution unit 13 executes logical inference using, as inputs, the processed background knowledge information and the processed query information.

An evaluation unit 14 outputs the processed background knowledge information and/or the processed query information, depending on whether or not an execution result of the logical inference satisfies a predetermined requirement.

<Flow of Logical Expression Processing Method>

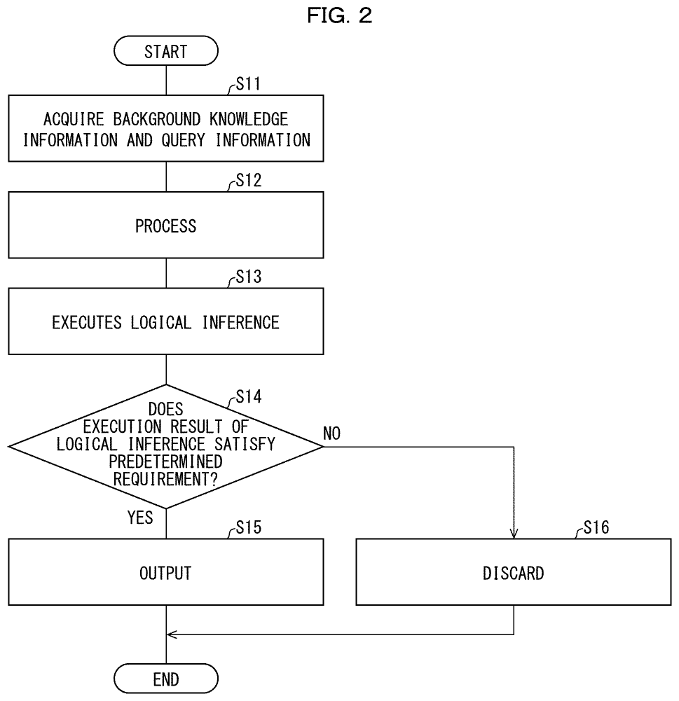

The following will discuss a flow of a logical expression processing method according to the present example embodiment, with reference to FIG. 2. FIG. 2 is a flowchart showing an example of a flow of the logical expression processing method according to the present example embodiment. As illustrated in FIG. 2, the logical expression processing method according to the present example embodiment includes at least steps S11 to S16.

In step S11 (acquisition step), the acquisition unit 11 acquires background knowledge information and query information.

In step S12 (processing execution step), the processing execution unit 12 processes a logical formula(s) of the background knowledge information and/or the query information that have been acquired by the acquisition unit 11 in step S11, and acquires processed background knowledge information and processed query information.

In step S13 (inference execution step), the inference execution unit 13 executes logical inference using, as inputs, the processed background knowledge information and the processed query information which have been obtained in step S12.

In step S14 (evaluation step), the evaluation unit 14 evaluates whether or not an execution result of the logical inference in step S13 satisfies a predetermined requirement. In a case where the execution result satisfies the predetermined requirement (YES in step S14), the evaluation unit 14 carries out a process in step S15. In a case where the execution result does not satisfy the predetermined requirement (NO in step S14), the evaluation unit 14 carries out a process in step S16.

In step S15 (evaluation step), the evaluation unit 14 outputs the processed background knowledge information and/or the processed query information which have been acquired in step S12.

In step S16 (evaluation step), the evaluation unit 14 discards the processed background knowledge information and the processed query information which have been acquired in step S12.

As described above, the logical expression processing apparatus 1 in accordance with the present example embodiment employs a configuration including: an acquisition unit 11 that acquires background knowledge information and query information, the background knowledge information expressing, in one or more logical formulas, a set of rules according to each of which if an antecedent is true, a consequent is true, the query information expressing one or more observed facts in one or more logical formulas; a processing execution unit 12 that processes the logical formula(s) of the background knowledge information and/or the query information that have been acquired by the acquisition unit 11, and acquires the background knowledge information and the query information for evaluation; an inference execution unit 13 that executes logical inference using, as inputs, the background knowledge information and the query information for evaluation; and an evaluation unit 14 that outputs the background knowledge information and/or the query information for evaluation, depending on whether or not an execution result of the logical inference satisfies a predetermined requirement.

Further, a logical expression processing method in accordance with the present example embodiment employs a configuration in which one or more computers is caused to: acquire background knowledge information and query information, the background knowledge information expressing, in one or more logical formulas, a set of rules according to each of which if an antecedent is true, a consequent is true, the query information expressing one or more observed facts in one or more logical formulas (step S11); process the logical formula(s) of the background knowledge information and/or the query information that have been acquired, and acquire the background knowledge information and the query information for evaluation (step S12); execute logical inference using, as inputs, the background knowledge information and the query information for evaluation (step S13); and output the background knowledge information and/or the query information for evaluation, depending on whether or not an execution result of the logical inference satisfies a predetermined requirement (steps S14 to S16).

According to experiences of the inventors of the present invention, in logical inference, appropriate processing procedures for respective inputs may be roughly classified into some patterns. Accordingly, an optimum processing procedure can be automatically found by trial and error, in a case where evaluation of a typical processing procedure is automated with use of the logical expression processing apparatus 1 and the logical expression processing method according to the present example embodiment. This makes it possible to automatically carry out a step that has conventionally been manually carried out, so that it is possible to reduce man-hours which are taken when the logical inference is applied to a real problem. Therefore, the present example embodiment makes it possible to efficiently adjust a logical expression format of input information in logical inference in a desired domain (applicability domain).

### Second Example Embodiment

The following description will discuss in detail a second example embodiment of the invention, with reference to drawings. Note that components having the same functions as those described in the first example embodiment are denoted by the same reference numerals, and descriptions thereof will be omitted accordingly.

(Logical Expression Processing Apparatus 2)

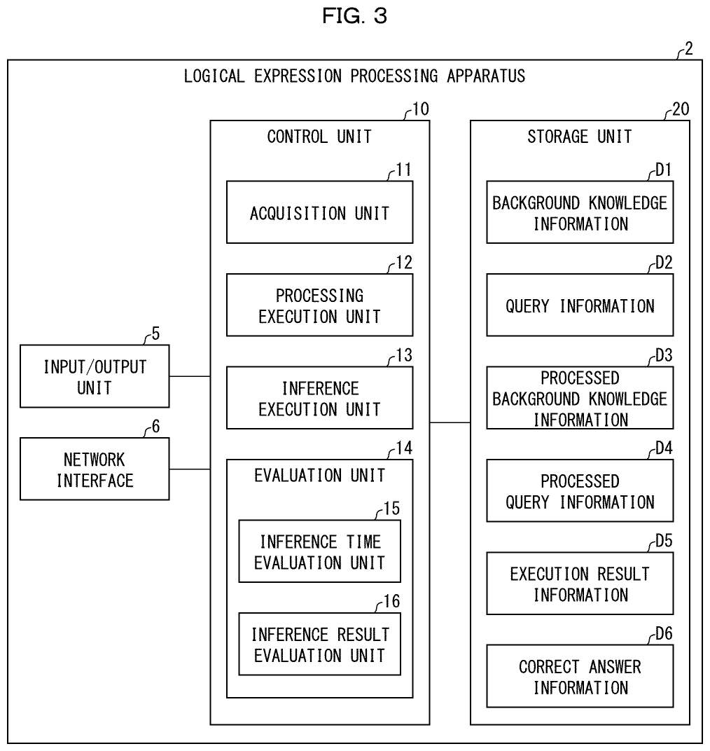

The following will discuss a configuration of a logical expression processing apparatus 2 according to the present example embodiment, with reference to FIG. 3. FIG. 3 is a block diagram illustrating an example of a configuration of the logical expression processing apparatus 2 according to the present example embodiment. The logical expression processing apparatus 2 may be constituted by one or more computers. The logical expression processing apparatus 2 may be arranged to be redundant in a plurality of computers, and each functional block may be implemented over the plurality of computers.

As illustrated in FIG. 3, the logical expression processing apparatus 2 includes an input/output unit 5, a network interface 6, a control unit 10 and a storage unit 20.

The input/output unit 5 is a device that carries out input/output between the logical expression processing apparatus 2 and the outside. The input/output unit 5 may include input devices such as a keyboard, a mouse, and a microphone, a read/write device for an external storage, output devices such as a display and a speaker, various input/output ports, and/or the like.

The network interface 6 is an interface used to communicate with any other apparatus and may include, for example, a network interface card (NIC).

The control unit 10 is a control unit that comprehensively controls the logical expression processing apparatus 2 and includes an acquisition unit 11, a processing execution unit 12, an inference execution unit 13 and an evaluation unit 14.

(Acquisition Unit 11)

As described above, the acquisition unit 11 acquires background knowledge information D1 and query information D2. Note that hereinafter, the background knowledge information D1 and the query information D2 that have been acquired by the acquisition unit 11 may be also referred to as unprocessed background knowledge information D1 and unprocessed query information D2.

In an example aspect, the acquisition unit 11 may acquire the unprocessed background knowledge information D1 and the unprocessed query information D2 via the input/output unit 5 or the network interface 6. In another example aspect, the acquisition unit 11 may read out the background knowledge information D1 and the query information D2 that are stored in the storage unit 20 incorporated in the logical expression processing apparatus 2.

(Processing Execution Unit 12)

The processing execution unit 12 processes a logical formula(s) of the unprocessed background knowledge information D1 and/or the unprocessed query information D2, and acquires processed background knowledge information D3 and processed query information D4. The processing execution unit 12 changes a logical expression format(s) of the background knowledge information and/or the query information while retaining the meaning represented by each piece of the information. In one example aspect, the processing execution unit 12 may process the logical formula of at least the unprocessed background knowledge information D1.

In the present example embodiment, the processing execution unit 12 can process the logical formula(s) of the unprocessed background knowledge information D1 and/or the unprocessed query information D2, according to one or more processing procedures different from each other.

In one example aspect, the processing execution unit 12 can process, according to each of one or more processing procedures, the logical formula(s) of the unprocessed background knowledge information D1 and/or the unprocessed query information D2, and can acquire, for each of the processing procedures, the processed background knowledge information D3 and the processed query information D4.

(Inference Execution Unit 13)

The inference execution unit 13 executes logical inference using, as inputs, the processed background knowledge information D3 and the processed query information D4.

In one example aspect, the inference execution unit 13 can execute the logical inference for each of the processing procedures.

In one example aspect, the inference execution unit 13 executes, with use of a logical inference model, the logical inference using, as inputs, the processed background knowledge information D3 and the processed query information D4. The logical inference model is not particularly limited, and may be a deductive reasoning model or an abductive reasoning model.

In one example aspect, the inference execution unit 13 may further acquire a correct answer inference result D6 by executing the logical inference using, as inputs, the unprocessed background knowledge information D1 and the unprocessed query information D2. Note that “correct answer” in the present specification is handled as a “correct answer” in evaluation carried out by the evaluation unit 14.

(Evaluation Unit 14)

An evaluation unit 14 outputs the processed background knowledge information D3 and/or the processed query information D4, depending on whether or not an execution result of the logical inference satisfies a predetermined requirement.

In one example aspect, the evaluation unit 14 can output, for each of the processing procedures, the processed background knowledge information D3 and/or the processed query information D4, depending on whether or not the execution result of the logical inference satisfies the predetermined requirement.

In one example aspect, the evaluation unit 14 may output, via the input/output unit 5, the processed background knowledge information D3 and/or the processed query information D4. In another example aspect, the evaluation unit 14 may record the processed background knowledge information D3 and/or the processed query information D4 in the storage unit 20 incorporated in the logical expression processing apparatus 2.

In one example aspect, the evaluation unit 14 may include an inference time evaluation unit 15 that evaluates whether or not the execution result of the logical inference satisfies a requirement related to a time taken for the logical inference.

In one example aspect, the evaluation unit 14 may include an inference result evaluation unit 16 that evaluates whether or not the execution result of the logical inference satisfies an inference result-related requirement.

The storage unit 20 stores the background knowledge information D1, the query information D2, the processed background knowledge information D3, the processed query information D4, the execution result information D5 and the correct answer information D6. In one example aspect, the storage unit 20 is configured by, for example, a nonvolatile storage apparatus such as a hard disk or a flash memory.

<Flow of Logical Expression Processing Method>

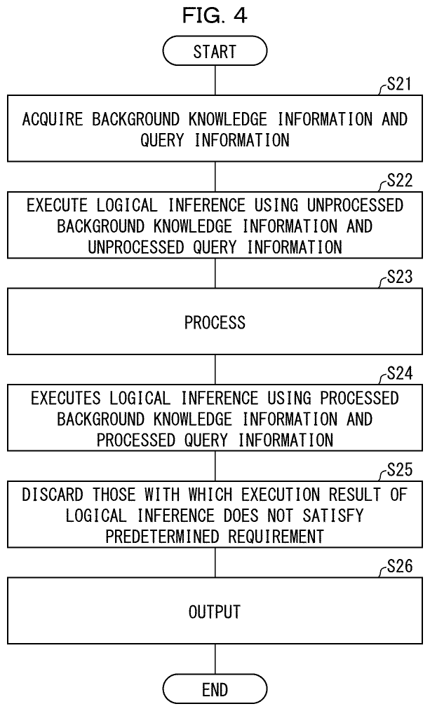

The following will discuss a flow of a logical expression processing method according to the present example embodiment, with reference to FIG. 4. FIG. 4 is a flowchart showing an example of a flow of the logical expression processing method according to the present example embodiment. As illustrated in FIG. 4, the logical expression processing method according to the present example embodiment includes at least steps S21 to S26.

In step 21 (acquisition step), the acquisition unit 11 acquires unprocessed background knowledge information D1 and unprocessed query information D2 via the input/output unit 5 or via the network interface 6 or from the storage unit 20.

(Background Knowledge Information D1)

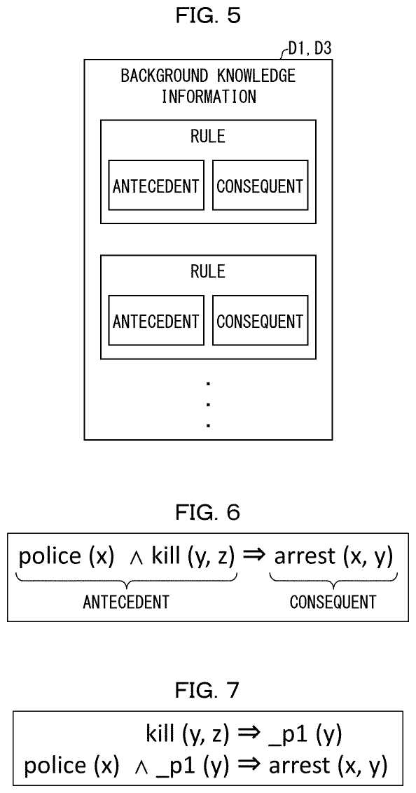

The background knowledge information D1 is, as described above, information expressing, in one or more logical formulas, a set of rules according to each of which if an antecedent is true, a consequent is true. FIG. 5 shows an example of a data structure of the background knowledge information D1.

As illustrated in FIG. 5, the background knowledge information D1 includes one or more pieces of data indicating rules. In one example aspect, each of the rules is expressed in a horn clause in first-order predicate logic, and data indicating each of the rules includes data indicating an antecedent and data indicating a consequent. In one example aspect, the antecedent and the consequent are each a logical conjunction of first-order predicate logic literals. A first-order predicate logic literal is an atomic formula or a negation of the atomic formula in the first-order predicate logic. In a case where a quantifier for a logical variable which is taken as an argument by each of literals in a rule is omitted, it is generally interpreted that a universal quantifier is applied to a variable included in an antecedent whereas an existential quantifier is applied to a variable included in only a consequent. The present specification is to follow such customary practice.

FIG. 6 is a diagram illustrating an example of the unprocessed background knowledge information D1. In the example illustrated in FIG. 6, the background knowledge information D1 includes a rule that if an antecedent (police (x)\hat{ }kill (y,z)) is true, a consequent (arrest (x,y)) is true. Note that the rule means “if x is a police and y kills z, x arrests y”. Note that in examples shown in the present specification, among arguments of a logical formula, logical variables are expressed in lower case, and logical constants are expressed in upper case.

(Query Information D2)

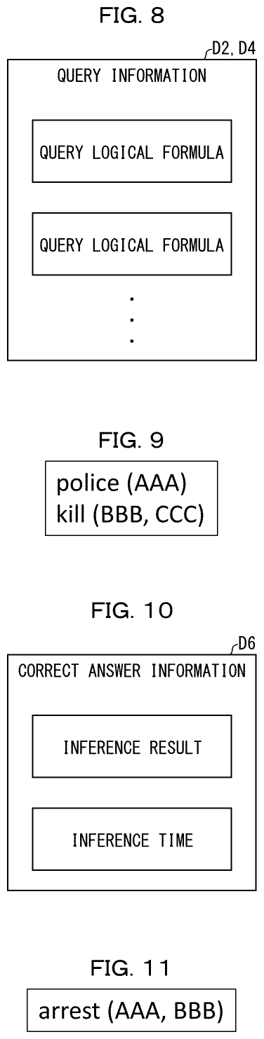

The query information D2 is, as described above, information expressing an observed fact in one or more logical formulas. Note that the observed fact need only be a fact that can be observed, and need not be actually observed. FIG. 8 shows an example of a data structure of the query information D2.

As illustrated in FIG. 8, the query information D2 includes one or more pieces of data each indicating a query logical formula. In one example aspect, the query logical formula is a logical conjunction of first-order predicate logical literals.

FIG. 9 is a diagram illustrating an example of the query information D2. In the example illustrated in FIG. 9, the query information D2 includes a query logical formula, that is, “police (AAA), kill (BBB, CCC)”. Note that the query logical formula indicates an observed fact that “AAA is a police. BBB killed CCC”.

In step 22 (inference execution step), the inference execution unit 13 executes logical inference using, as inputs, the unprocessed background knowledge information D1 and the unprocessed query information D2 and as a result, acquires the correct answer information D6.

FIG. 10 is a diagram illustrating an example of a data structure of the correct answer information D6. As illustrated in FIG. 10, in one example aspect, the correct answer information D6 may include an inference result and an inference time. The inference result indicates a correct answer that is expected as an inference result of the logical inference. The inference time indicates an appropriate value that is expected as a time taken for the logical inference. The format of an individual inference result is defined by the logical inference model used by the inference execution unit 13. The format of the individual inference result is basically expressed as a logical conjunction of first-order predicate logical formulas. Note that in one example aspect, the inference execution unit 13 may store the correct answer information D6 in the storage unit 20.

FIG. 11 is a diagram illustrating an example of the inference result of the correct answer information D6. In the example described above, the unprocessed background knowledge information D1 includes a rule that if an antecedent (police (x)\hat{ }kill (y,z)) is true, a consequent (arrest (x,y)) is true, and the query information D2 includes a query logical formula “police (AAA), kill (BBB, CCC)”. Therefore, as illustrated in FIG. 11, the inference result of the correct answer information D6 includes an inference result “arrest (AAA, BBB)”. The inference result means “AAA arrests BBB”.

In step 23 (processing execution step), the processing execution unit 12 processes the logical formula(s) of the unprocessed background knowledge information D1 and/or the unprocessed query information D2, and acquires processed background knowledge information D3 and processed query information D4. In one example aspect, the processing execution unit 12 may store, in the storage unit 20, the processed background knowledge information D3 and the processed query information D4.

In one example aspect, as illustrated in FIG. 5, a data structure of the processed background knowledge information D3 may be the same as the data structure of the unprocessed background knowledge information D1. Further, as illustrated in FIG. 8, the data structure of the processed query information D4 may be the same as the data structure of the unprocessed query information D2.

The processing execution unit 12 does not need to process the logical formulas of both of the unprocessed background knowledge information D1 and the unprocessed query information D2. For example, in a case where the processing execution unit 12 processes only the logical formula of the unprocessed background knowledge information D1, the processed query information D4 is the same as the unprocessed query information D2.

The processing execution unit 12 may process only the logical formula of the unprocessed background knowledge information D1. Alternatively, the processing execution unit 12 may process only the logical formula of the unprocessed query information D2. Alternatively, the processing execution unit 12 may process the logical formulas of both of the unprocessed background knowledge information D1 and the unprocessed query information D2. The expression “process a logical formula” means to change the content of an original logical formula, to delete the original logical formula, to add a new logical formula, and the like.

In one example aspect, the processing execution unit 12 processes, according to one or more processing procedures, the logical formula(s) of the unprocessed background knowledge information D1 and/or the unprocessed query information D2, and may acquire, for each of the processing procedures, the processed background knowledge information D3 and the processed query information D4. In this case, the processing execution unit 12 may store, in the storage unit 20, the processed background knowledge information D3 and the processed query information D4 in association with a processing procedure that has been used to acquire the processed background knowledge information D3 and the processed query information D4.

Here, the processing procedure is a procedure for defining which rule is to be followed by the processing execution unit 12 for processing the logical formula. Examples of the processing procedure include, but are not limited to, the following procedures: a processing procedure for excluding a redundant argument included in a predicate of the unprocessed background knowledge information D1 and the unprocessed query information D2; a processing procedure for decomposing a certain predicate into different predicates; a processing procedure that integrates a plurality of predicates into a single predicate; and combinations thereof.

Examples of the processing procedure include a procedure in which: if in the rule included in the unprocessed background knowledge information D1, an argument that is not included in the consequent is included in the antecedent a logical formula containing the argument is replaced by another logical formula in which the argument is abstracted; and then, a rule is newly added in which the logical formula prior to this replacement is set as the antecedent and the logical formula after the replacement is set as the consequent. FIG. 7 shows an example of the processed background knowledge information D3 that has been obtained by processing the background knowledge information D1 illustrated in FIG. 6, with use of the above processing procedure. The example of the processed background knowledge information D3 illustrated in FIG. 7 is obtained by: first, replacing, by another logical formula “p1 (y)”, the logical formula “kill (y, z)” including the argument z that is not included in the consequent in the background knowledge information D1 illustrated in FIG. 6; and then newly adding a rule in which the logical formula “kill (y, z)” prior to such replacement is set as the antecedent and the logical formula “p1 (y)” after the replacement is set as the consequent.

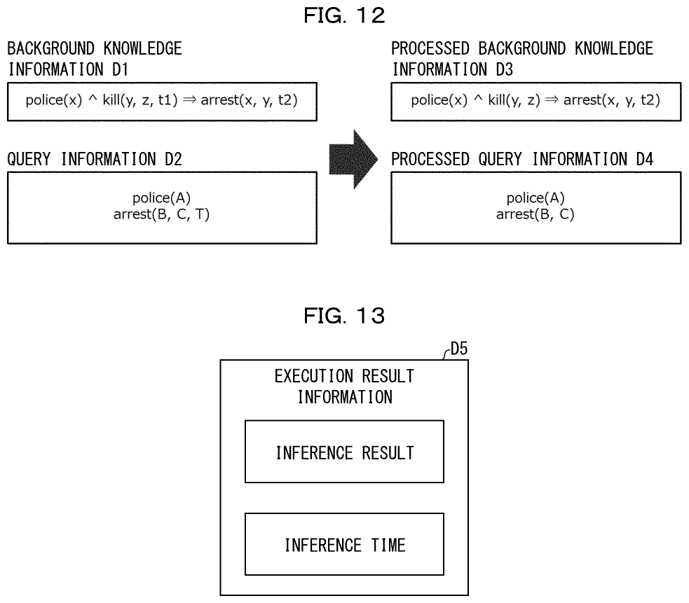

Further, examples of the processing procedure also include a procedure in which, if at least one argument included in a predicate of the unprocessed background knowledge information D1 and the unprocessed query information D2 does not contribute to the inference result, all logical formulas having the predicate which are contained in the unprocessed background knowledge information D1 and the unprocessed query information D2 are processed so as to have a logical expression in which the argument that does not contribute to the inference result is removed. FIG. 12 shows an example of processing with use of the processing procedure. In the example illustrated in FIG. 12, considered are the following logical formulas: arrest (x, y, t) and kill (x, y, t) which respectively represent a state in which “x arrests y at time t” and a state in which “x kills y at time t”. In this case, the argument t representing the time does not contribute to the inference result. For this reason, in the example illustrated in FIG. 12, all logical formulas which have “arrest” and “kill” in predicates and which are included in the unprocessed background knowledge information D1 and the unprocessed query information D2 are processed into logical expressions in each of which the argument representing time is removed, so that the processed background knowledge information D3 and the processed query information D4 are obtained.

In step 24 (inference execution step), the inference execution unit 13 executes logical inference using, as inputs, the processed background knowledge information D3 and the processed query information D4, and acquires execution result information D5. In one example aspect, the inference execution unit 13 may store the execution result information D5 in the storage unit 20.

In one example aspect, the inference execution unit 13 executes, with use of the logical inference model, the logical inference using, as inputs, the processed background knowledge information D3 and the processed query information D4. The logical inference model is not particularly limited, and may be a deductive reasoning model or an abductive reasoning model.

FIG. 13 is a diagram illustrating an example of a data structure of the execution result information D5. As illustrated in FIG. 13, the execution result information D5 includes an inference result and an inference time. The inference result shows an execution result of the logical inference in step S24. The format of an individual inference result is defined by the logical inference model used by the inference execution unit 13. The format of the individual inference result is basically expressed as a logical conjunction of first-order predicate logical formulas. The inference time indicates the time taken for the logical inference in step S24.

In one example aspect, the inference execution unit 13 can execute, for each of the processing procedures, logical inference using, as inputs, the processed background knowledge information D3 and the processed query information D4 which correspond to the each of the processing procedure. In this case, the inference execution unit 13 may store, in the storage unit 20, the execution result information D5 in association with the processing procedure corresponding to the logical inference used to acquire the execution result information D5.

In step 25 (evaluation step), the evaluation unit 14 discards the processed background knowledge information D3 and the processed query information D4 with which the execution result information D5 does not satisfy the predetermined requirement.

In one example aspect, the evaluation unit 14 determines as follows whether or not the execution result information D5 satisfies the predetermined requirement.

Here, the predetermined requirement may be freely defined in accordance with a purpose. For example, if the purpose is to shorten the inference time, it may be determined whether or not the time taken for inference is within a predetermined time. Alternatively, if the purpose is to make it possible to obtain an expected inference result, it may be determined whether or not the content of the inference result satisfies a specific logical formula or the like.

The inference time evaluation unit 15 refers to the inference time of the execution result information D5 acquired in step 24, and determines whether or not the inference time is improved from that of the correct answer information D6 which has been acquired in step 22.

Further, the inference result evaluation unit 16 compares the inference result of the execution result information D5 that has been acquired in step 24 and the inference result of the correct answer information D6 that has been acquired in step 22, and thereby determines whether or not the execution result information D5 satisfies the inference result-related requirement.

It is possible to freely define a criterion for determining whether or not those inference results are the same, in accordance with, for example, a domain (target region) which is a target of the logical inference and the logical inference model which is used by the inference execution unit 13. The inference result evaluation unit 16 may make such a determination, for example, on the basis of whether or not logical conjunctions of the inference result of the execution result information D5 and the inference result of the correct answer information D6 totally match each other or alternatively, on the basis of whether or not arguments in logical formulas each having a specific predicate in those inference results matches with each other. Further, a user may determine whether or not those inference results are the same through a user interface or the like.

In step 26 (evaluation step), the inference result evaluation unit 16 outputs the processed background knowledge information D3 and the processed query information D4 with which the execution result information D5 satisfies the predetermined requirement.

The present example embodiment employs a method in which: processing means are automated as respective procedures, and an actual trial is made so that which one of the means is effective in a target domain can be found. This makes it possible to automatically carry out a step that has conventionally been manually carried out. This makes it possible to reduce man-hours which are taken when the logical inference is applied to a real problem.

The following will discuss specific examples. Here, Markov logic networks are used as the logical inference model, and it is assumed that the background knowledge information D1 shown as an example in FIG. 6 and the query information D2 shown as an example in FIG. 9 are inputted. Further, considered is the case of employing, as the processing procedure, a procedure in which with regard to the rule of the background knowledge information D1, if the antecedent contains an argument that is not included in the consequent, a logical formula having the argument is replaced with another logical formula in which the argument is removed, and then, a rule that derives a logical formula after replacement from the logical formula prior to the replacement is newly added.

At this time, prior to processing, the inference execution unit 21 executes, by the Markov logic networks, inference using, as inputs, the background knowledge information D1 and the query information D2, and acquires an inference result. The inference result is stored in the storage unit 20 as the correct answer information D6.

Next, the processing execution unit 12 applies the processing procedure to the background knowledge information D1 and the query information D2. The processing execution unit 12 then stores, in the storage unit 20, a result of such application as the processed background knowledge information D3 and the processed query information D4. As a result, it is possible to obtain, as the processed background knowledge information D4, the background knowledge illustrated as an example in FIG. 7. Since the processing procedure used here is for only inference rules, the processed query information D4 and the query information D2 are completely identical to each other.

After processing, the inference execution unit 21 executes, by the Markov logic networks, inference using, as inputs, the processed background knowledge information D3 and the processed query information D4, and acquires an inference result. The inference result is stored, as the execution result information D5, in the storage unit 20.

Thereafter, the inference time evaluation unit 24 compares the inference time of the correct answer information D6 and the inference time of the execution result information D5 with each other. Generally, the computation complexity of Markov logic networks depends on the number of combinations of constants that can be arguments of respective inference rules. Therefore, in the present example, it is expected that the inference time is shorter after processing. On the other hand, in a case where the inference time after processing has not been improved, the inference time evaluation unit 24 determines that the processing procedure does not lead to an improvement in computation efficiency in the target domain. The inference time evaluation unit 24 then discards the processed background knowledge information D3 and the processed query information D4.

Further, the inference content evaluation unit 24 compares the inference result of the correct answer information D6 and the inference result of the execution result information D5 with each other, and checks whether the inference result has been unchanged or changed. Since the processing procedure used in the present example is logically equivalent, it is obvious that the inference result does not change before and after the processing. On the other hand, the inference result may change depending on the processing procedure used. In such a case, the inference content evaluation unit 24 determines that the processing procedure cannot be used in the target domain, and discards the processed background knowledge information D3 and the processed query information D4.

In a case where the inference time is improved and the inference result is unchanged, the evaluation unit 14 outputs, as results of improvement in inference efficiency, the processed background knowledge information D3 and the processed query information D4.

As described above, in the present example, it is possible to automatically seek for rewriting that improves the inference time, within a range that does not change the inference result. This makes it possible to realize an operation for rewriting of an expression format with fewer man-hours though the operation has conventionally been carried out manually by repeatedly performing inference execution and time measurement. This can be expected to be useful in practical use.

### Third Example Embodiment

The following description will discuss in detail a third example embodiment of the invention, with reference to drawings. Note that components having the same functions as those described in the first example embodiment and the second example embodiment are denoted by the same reference numerals, and descriptions thereof will be omitted accordingly.

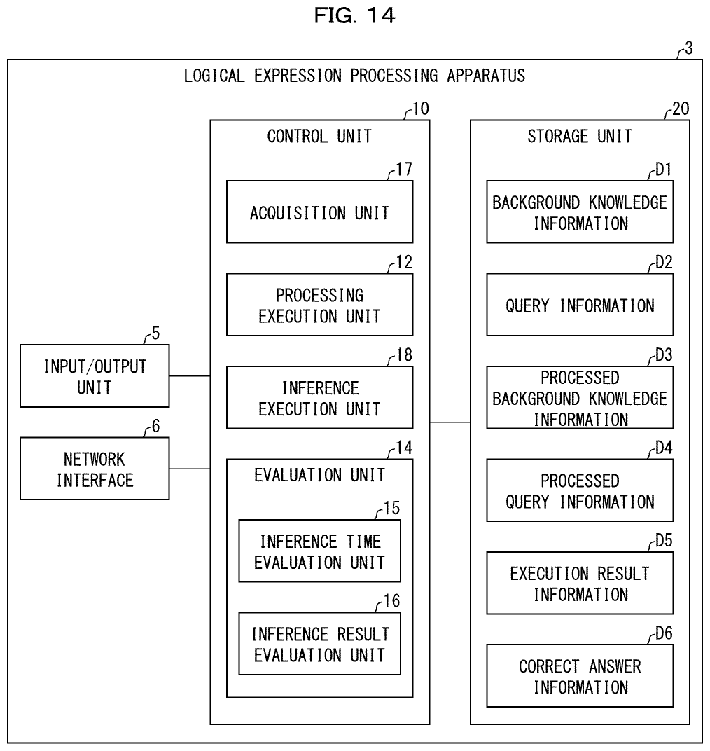

The following will discuss a configuration of a logical expression processing apparatus 3 according to the present example embodiment, with reference to FIG. 14. FIG. 14 is a block diagram illustrating a configuration of the logical expression processing apparatus 3 according to the present example embodiment.

As illustrated in FIG. 14, the logical expression processing apparatus 3 is different from the logical expression processing apparatus 2 in that a control unit 10 includes an acquisition unit 17 rather than an acquisition unit 11 and also includes an inference execution unit 18 rather than an inference execution unit 13. Other configurations of the logical expression processing apparatus 3 are the same as those of the logical expression processing apparatus 2.

More specifically, the acquisition unit 17 further acquires correct answer information D6 in addition to background knowledge information D1 and query information D2. The evaluation unit 14 compares execution result information D5, which has been obtained by using processed background knowledge information D3 and processed query information D4 as inputs, with the correct answer information D6 that has been acquired by the acquisition unit 17, and thereby determines whether or not the execution result information D5 satisfies an inference result-related requirement.

Note that the inference execution unit 18 does not execute logical inference using, as inputs, the unprocessed background knowledge information D1 and the unprocessed query information D2. Since the acquisition unit 17 acquires the correct answer information D6, execution of the logical inference is unnecessary.

<Flow of Logical Expression Processing Method>

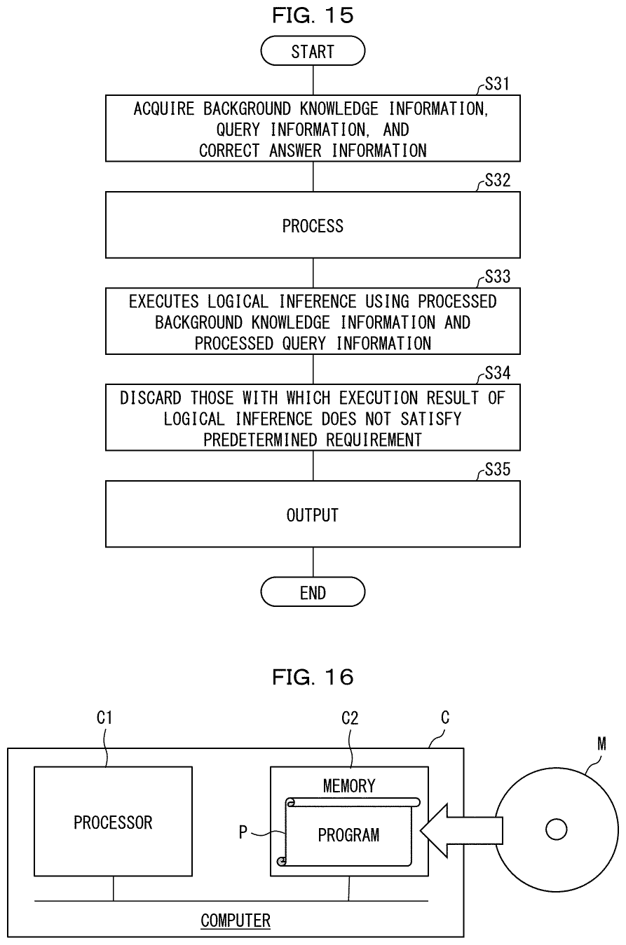

The following will discuss a flow of a logical expression processing method according to the present example embodiment, with reference to FIG. 15. FIG. 15 is a flowchart showing a flow of the logical expression processing method according to the present example embodiment. As illustrated in FIG. 15, the logical expression processing method according to the present example embodiment includes at least steps S31 to S35.

In step 31 (acquisition step), the acquisition unit 17 acquires the background knowledge information D1, the query information D2 and the correct answer information D6.

In step 32 (processing execution step), the processing execution unit 12 processes a logical formula(s) of the unprocessed background knowledge information D1 and/or the unprocessed query information D2 which have been acquired by the acquisition unit 11. As a result, the processing execution unit 12 acquires the processed background knowledge information D3 and the processed query information D4 for evaluation.

In step 33 (inference execution step), the inference execution unit 18 executes logical inference using, as inputs, the processed background knowledge information D3 and the processed query information D4, and acquires the execution result information D5, which is an execution result of the logical inference.

In step 34 (evaluation step), the inference result evaluation unit 16 discards the processed background knowledge information D3 and the processed query information D4 with which the execution result information D5 does not satisfy a predetermined requirement. The inference result evaluation unit 16 compares the execution result information D5 that has been acquired in step 33 with the correct answer information D6 that has been acquired in step 31, and thereby determines whether or not the execution result information D5 satisfies the inference result-related requirement.

In step 35 (evaluation step), the inference result evaluation unit 16 outputs the processed background knowledge information D3 and the processed query information D4 with which the execution result information D5 satisfies the predetermined requirement.

### Hardware and Software Implementation Examples

Some or all of components of the logical expression processing apparatuses 1 to 3 can be realized by general-purpose or dedicated circuitry, a general-purpose or dedicated processor, or the like, or a combination thereof. Such circuitry, processor or the like may be constituted by a single chip or alternatively a plurality of chips that are connected to each other via a bus. Some or all of the components of each of the apparatuses can be realized by a combination of software and the above-described circuitry and/or the like.

When the some or all of the components of the logical expression processing apparatuses 1 to 3 are realized by a plurality of information processing apparatuses, circuitry, and/or the like, the plurality of information processing apparatuses, circuitry, and/or the like may be disposed in a concentrated manner or in a distributed manner. For example, the information processing apparatuses, the circuitry, and/or the like may be realized such that each of a client server system, a cloud computing system, and/or the like is connected via a communication network. Further, the functions of the logical expression processing apparatuses 1 to 3 may be provided in a “software as a service” (SaaS) form.

In a case where the functions of some or all of the logical expression processing apparatuses 1 to 3 are realized by software, the logical expression processing apparatuses 1 to 3 are realized by, for example, a computer that executes instructions of a program that is software realizing the foregoing functions. FIG. 16 illustrates an example of such a computer (hereinafter, referred to as “computer C”). The computer C includes at least one processor C1 and at least one memory C2. In the memory C2, a program P for causing the computer C to operate as the logical expression processing apparatuses 1 to 3 is stored. In the computer C, the foregoing functions of the logical expression processing apparatuses 1 to 3 can be realized by the processor C1 reading and executing the program P stored in the memory C2.

Examples of the processor C1 encompass a central processing unit (CPU), a graphic processing unit (GPU), a field-programmable gate array (FPGA), a digital signal processor (DSP), a micro processing unit (MPU), a floating point number processing unit (FPU), a physics processing unit (PPU), and a microcontroller. Further, as a processor, a central processing unit (CPU), a graphic processing unit (GPU), or a combination thereof can be used. The memory C2 can be, for example, a flash memory, a hard disk drive (HDD), a solid state drive (SSD), or a combination thereof.

Note that the computer C may include, as the memory C2, a volatile storage apparatus such as a random access memory (RAM) in which the program P is loaded when the program P is executed and in which various kinds of data are temporarily stored. The computer C can further include a communication interface for carrying out transmission and reception of data to/from another apparatus(es). The computer C can further include an input/output interface for connecting input-output apparatuses such as a keyboard, a mouse, a display and a printer.

The program P can be stored in a non-transitory tangible storage medium M that can be read by the computer C. Examples of the storage medium M encompass a tape, a disk, a card, a semiconductor memory, and a programmable logic circuit. The computer C can obtain the program P via such a storage medium M. Further, the program P can be transmitted via a transmission medium. Examples of the transmission medium encompass a communication network or a broadcast wave. The computer C can obtain the program P via such a transmission medium.

[Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

[Additional Remark 2]

The whole or part of the example embodiments disclosed above can be described as, but not limited to, the following supplementary notes.

(Supplementary note 1)

A logical expression processing apparatus including:
an acquisition unit that acquires background knowledge information and query information, the background knowledge information expressing, in one or more logical formulas, a set of rules according to each of which if an antecedent is true, a consequent is true, the query information expressing one or more observed facts in one or more logical formulas;
a processing execution unit that processes the logical formulas of at least one of the background knowledge information and the query information that have been acquired by the acquisition unit, and acquires processed background knowledge information and processed query information;
an inference execution unit that executes logical inference using, as inputs, the processed background knowledge information and the processed query information; and
an evaluation unit that outputs at least one of the processed background knowledge information and the processed query information, depending on whether or not an execution result of the logical inference satisfies a predetermined requirement.

The above configuration makes it possible to efficiently adjust the logical expression format of input information in logical inference.

(Supplementary note 2)

The logical expression processing apparatus according to supplementary note 1, wherein:
the processing execution unit processes, according to each of one or more processing procedures, the logical formulas of at least one of the background knowledge information and the query information that have been acquired by the acquisition unit, and acquires, for each of the processing procedures, the processed background knowledge information and the processed query information;
the inference execution unit executes the logical inference for each of the processing procedures; and
the evaluation unit outputs, for each of the processing procedures, the at least one of the processed background knowledge information and the processed query information, depending on whether or not the execution result of the logical inference satisfies the predetermined requirement.

The above configuration makes it possible to evaluate each of one or more processing procedures, and therefore, makes it possible to more efficiently adjust the logical expression format of input information in logical inference.

(Supplementary note 3)

The logical expression processing apparatus according to supplementary note 1 or 2, wherein
the execution result of the logical inference includes a time taken for the logical inference and the predetermined requirement includes a requirement related to the time taken for the logical inference.

The above configuration makes it possible to adjust the logical expression format of input information so that much time will not be taken for the logical inference.

(Supplementary note 4)

The logical expression processing apparatus according to any one of supplementary notes 1 to 3, wherein
the predetermined requirement includes a requirement related to an inference result of the logical inference.

The above configuration makes it possible to adjust the logical expression format of input information so that a desired inference result can be obtained.

(Supplementary note 5)

The logical expression processing apparatus according to supplementary note 4, wherein:
the inference execution unit executes the logical inference using, as inputs, the background knowledge information and the query information that have been acquired by the acquisition unit, and acquires a correct answer inference result; and
the evaluation unit compares the correct answer inference result and the inference result of the logical inference using, as the inputs, the processed background knowledge information and the processed query information, and thereby determines whether or not the execution result satisfies the requirement related to the inference result.

The above configuration makes it possible to acquire a correct answer inference result from unprocessed background knowledge information and unprocessed query information, and adjust the logical expression format of input information so that a desired inference result can be acquired.

(Supplementary note 6)

The logical expression processing apparatus according to supplementary note 4, wherein:
the acquisition unit further acquires a correct answer inference result; and
the evaluation unit compares the correct answer inference result and the inference result of the logical inference using, as the inputs, the processed background knowledge information and the processed query information, and thereby determines whether or not the execution result satisfies the requirement related to the inference result.

The above configuration allows the acquisition unit to acquire the correct answer inference result, and makes it possible to adjust the logical expression format of input information so that a desired inference result can be obtained.

(Supplementary note 7)

A logical expression processing method, wherein one or more computers is caused to:
acquire background knowledge information and query information, the background knowledge information expressing, in one or more logical formulas, a set of rules according to each of which if an antecedent is true, a consequent is true, the query information expressing one or more observed facts in one or more logical formulas;
process the logical formulas of at least one of the background knowledge information and the query information that have been acquired, and acquire processed background knowledge information and processed query information;
execute logical inference using, as inputs, the processed background knowledge information and the processed query information; and
output at least one of the processed background knowledge information and the processed query information, depending on whether or not an execution result of the logical inference satisfies a predetermined requirement.

According to the method, an effect similar to that of supplementary note 1 is brought about.

(Supplementary note 8)

A logical expression processing program causing a computer to function as a logical expression processing apparatus,
the logical expression processing program causing the computer to function as:
an acquisition unit that acquires background knowledge information and query information, the background knowledge information expressing, in one or more logical formulas, a set of rules according to each of which if an antecedent is true, a consequent is true, the query information expressing one or more observed facts in one or more logical formulas;
a processing execution unit that processes the logical formulas of at least one of the background knowledge information and the query information that have been acquired by the acquisition unit, and acquires processed background knowledge information and processed query information;
an inference execution unit that executes logical inference using, as inputs, the processed background knowledge information and the processed query information; and
an evaluation unit that outputs at least one of the processed background knowledge information and the processed query information, depending on whether or not an execution result of the logical inference satisfies a predetermined requirement.

According to the above logical expression processing program, an effect similar to that of supplementary note 1 is brought about.

[Additional Remark 3]

Some of or all of the foregoing example embodiments can further be expressed as below.

A logical expression processing apparatus includes at least one processor, the at least one processor carrying out:
an acquisition process of acquiring background knowledge information and query information, the background knowledge information expressing, in one or more logical formulas, a set of rules according to each of which if an antecedent is true, a consequent is true, the query information expressing one or more observed facts in one or more logical formulas;
a processing execution process of processing the logical formulas of at least one of the background knowledge information and the query information that have been acquired by the acquisition unit, and acquiring processed background knowledge information and processed query information;
an inference execution process of executing logical inference using, as inputs, the processed background knowledge information and the processed query information; and
an evaluation process of outputting at least one of the processed background knowledge information and the processed query information, depending on whether or not an execution result of the logical inference satisfies a predetermined requirement.

Note that this communication apparatus can further include a memory. In this memory, it is possible to store a program for causing the processor to carry out the acquisition process, the acquisition process, the processing execution process, the inference execution process, and the evaluation process. Further, the program can be stored in a computer-readable non-transitory tangible storage medium.

### REFERENCE SIGNS LIST

1 to 3 logical expression processing apparatus
10, 17 control unit
11 acquisition unit
12 processing execution unit
13, 18 inference execution unit
14 evaluation unit
15 inference time evaluation unit
16 inference result evaluation unit
20 storage unit
D1 background knowledge information
D2 query information
D3 processed background knowledge information
D4 processed query information
D5 execution result information
D6 correct answer information

What is claimed is:

1. A logical expression processing apparatus comprising at least one processor,
the at least one processor carrying out:
an acquisition process of acquiring background knowledge information and query information, the background knowledge information expressing, in one or more logical formulas, a set of rules according to each of which if an antecedent is true, a consequent is true, the query information expressing one or more observed facts in one or more logical formulas;
a processing execution process of processing the logical formulas of at least one of the background knowledge information and the query information that have been acquired in the acquisition process, and acquiring processed background knowledge information and processed query information;
an inference execution process of executing logical inference using, as inputs, the processed background knowledge information and the processed query information; and
an evaluation process of outputting at least one of the processed background knowledge information and the processed query information, depending on whether or not an execution result of the logical inference satisfies a predetermined requirement.

2. The logical expression processing apparatus according to claim 1, wherein:
in the processing execution process, the at least one processor processes, according to each of one or more processing procedures, the logical formulas of at least one of the background knowledge information and the query information that have been acquired in the acquisition process, and acquires, for each of the processing procedures, the processed background knowledge information and the processed query information;
in the inference execution process, the at least one processor executes the logical inference for each of the processing procedures; and
in the evaluation process, the at least one processor outputs, for each of the processing procedures, the at least one of the processed background knowledge information and the processed query information, depending on whether or not the execution result of the logical inference satisfies the predetermined requirement.

3. The logical expression processing apparatus according to claim 1, wherein
the execution result of the logical inference includes a time taken for the logical inference and the predetermined requirement includes a requirement related to the time taken for the logical inference.

4. The logical expression processing apparatus according to claim 1, wherein
the predetermined requirement includes a requirement related to an inference result of the logical inference.

5. The logical expression processing apparatus according to claim 4, wherein:
in the inference execution process, the at least one processor executes the logical inference using, as inputs, the background knowledge information and the query information that have been acquired in the acquisition process, and acquires a correct answer inference result; and
in the evaluation process, the at least one processor compares the correct answer inference result and the inference result of the logical inference using, as the inputs, the processed background knowledge information and the processed query information, and thereby determines whether or not the execution result satisfies the requirement related to the inference result.

6. The logical expression processing apparatus according to claim 4, wherein:
in the acquisition process, the at least one processor further acquires a correct answer inference result; and
in the evaluation process, the at least one processor compares the correct answer inference result and the inference result of the logical inference using, as the inputs, the processed background knowledge information and the processed query information, and thereby determines whether or not the execution result satisfies the requirement related to the inference result.

7. A logical expression processing method, wherein one or more computers is caused to:
acquire background knowledge information and query information, the background knowledge information expressing, in one or more logical formulas, a set of rules according to each of which if an antecedent is true, a consequent is true, the query information expressing one or more observed facts in one or more logical formulas;
process the logical formulas of at least one of the background knowledge information and the query information that have been acquired, and acquire processed background knowledge information and processed query information;
execute logical inference using, as inputs, the processed background knowledge information and the processed query information; and
output at least one of the processed background knowledge information and the processed query information, depending on whether or not an execution result of the logical inference satisfies a predetermined requirement.

8. A non-transitory storage medium in which a logical expression processing program is stored, the logical expression processing program causing a computer to carry out
an acquisition process of acquiring background knowledge information and query information, the background knowledge information expressing, in one or more logical formulas, a set of rules according to each of which if an antecedent is true, a consequent is true, the query information expressing one or more observed facts in one or more logical formulas;
a processing execution process of processing the logical formulas of at least one of the background knowledge information and the query information that have been acquired in the acquisition process, and acquiring processed background knowledge information and processed query information;
an inference execution process of executing logical inference using, as inputs, the processed background knowledge information and the processed query information; and
an evaluation process of outputting at least one of the processed background knowledge information and the processed query information, depending on whether or not an execution result of the logical inference satisfies a predetermined requirement.
